(19) United States
(12) Patent Application Publication
(10) Pub. No.: US 2017/0228101 A1
(43) Pub. Date: Aug. 10, 2017

(54) ADAPTIVE FILTERING METHOD FOR GESTURAL AND TOUCH-SENSITIVE INTERFACE, AND INTERFACE MECHANISM IMPLEMENTING THE METHOD

(71) Applicant: QuickStep Technologies LLC, Wilmington, DE (US)

(72) Inventor: Eric LEGROS, Ales (FR)

(21) Appl. No.: 15/502,145

(22) PCT Filed: Aug. 4, 2015
(86) PCT No.: PCT/EP2015/067887

§ 371 Date: Feb. 6, 2017

(30) Foreign Application Priority Data
Aug. 7, 2014 (FR) 1457663

(51) Int. Cl. G06F 3/041; G06F 3/044

(52) U.S. Cl. CPC G06F 3/0418; G06F 3/044; G06F 2203/04101

(57) ABSTRACT

The present invention relates to a method for filtering a measurement signal Mi resulting from a capacitive coupling between a measurement electrode and at least one object of interest, which comprises the steps of (i) generating a filtered signal Mo from the measurement signal Mi, with the application of an adaptive filtering function implementing a strength parameter Af depending on the measurement signal Mi at a preceding moment and an electrical noise, (ii) generating a derivative signal Der representative of variations of said filtered signal Mo, (iii) generating a compensated signal Moc, with a linear combination of said filtered signal Mo and said derivative signal Der.

The invention also relates to an interface mechanism and an apparatus implementing the method.

### TECHNICAL DOMAIN

The present invention relates to a method for processing measurement signals corresponding to objects of interest interacting with a gestural or touch-sensitive capacitive interface and in particular filtering measurement noise. It also relates to an interface mechanism or a measurement mechanism implementing the method.

The field of the invention is more particularly, but without limitation, that of touch-sensitive and contactless human-machine interfaces.

### STATE OF THE PRIOR ART

Many apparatuses use touch-sensitive or contactless measurement interfaces such as human-machine interfaces to enter commands. These interfaces may in particular take the form of touch-sensitive pads or screens. Examples include mobile telephones, smartphones, touch-screen computers, pads, PCs, mice, touch-sensitive pads and giant screens, etc.

These interfaces frequently use capacitive technologies. The measurement surface is equipped with conducting electrodes. Electronic means make it possible to measure the electrical capacitances that appear between these electrodes and one or more objects to be detected, which makes it possible to localize these objects and deduce commands to be performed therefrom.

It is possible to implement transparent electrodes, which make it possible to superimpose an interface on a display screen, for example a smartphone.

Most of these interfaces are touch-sensitive, i.e., they can detect the contact of one or more object(s) of interest or command object (such as fingers or a stylus) with the surface of the interface.

Increasing number of gestural or contactless interfaces are being developed, which are able to detect command objects at a greater distance from the interface, without contact with the surface.

The development of contactless interfaces requires the implementation of capacitance measurement techniques with a very high sensitivity and offering great immunity to disruptions from the environment. Indeed, the capacitance that is created between the capacitance measurement electrodes of the interface and command objects is inversely proportional to the distance that separates them.

Known for example is the Rozière patent FR 2,949,007 by, which discloses a capacitance measurement technique that makes it possible to measure the capacitance and the distance between a plurality of independent electrodes and a nearby object.

This technique makes it possible to obtain capacitance measurements between the electrodes and the objects with high resolution and sensitivity, making it possible for example to detect a finger several centimeters away from the surface of the interface. The detection of the command objects can thus be done in a three-dimensional space near the surface of the interface, or in contact with that surface.

The detection of command objects at great distances from the surface, in “hovering” mode, leads to working in zones where the detection sensitivity is very low.

Hence, the measurement is disrupted by many noise sources, including:
the thermal noise intrinsic to the measurement electronics;
the noise caused by voltage sources outside the mechanism that interfere with the measurement signal.

Thus, in remote zones, the detection still provides a sensitivity to the remote object, but the thermal detection noise makes the measurement noisy and unusable.

More specifically, the detection of command objects at distances Z requires the measurement of capacitive couplings C that change like the inverse of this distance Z: C˜1/Z. Their variation dC/dZ therefore changes like 1/Z² with the distance Z. It follows that the signal-to-noise ratio for the thermal noise or noise of outside origin also evolves in 1/Z² with the distance Z.

It is therefore necessary to significantly filter the measurements to make the signal usable at large distances.

However, the conventional linear filters tend to excessively disrupt the dynamic characteristics of the signal.

They in particular cause a trailing effect, with the detected point moving “late” relative to the actual movement of the command object.

This trailing of the response is a limitation for a use of the mechanism (telephone, smartphone, tablet) with quick gestures.

In case of rapid alternating movement (to command the movement of a virtual object in a game through repeated accelerations of the finger, for example), in addition to the delay caused on the position of the virtual object and the loss of amplitude of the acceleration, this trailing effect may even cause a disappearance of the movement, beyond a certain speed.

Furthermore, when the filtering is significant and the object is moved between two positions, a memory effect is observed at the former position of the object, and a trail between the initial and final positions. So-called ghost detected points may then appear, either on the obsolete, former position, or between the old position and the new one.

In order to improve the dynamic behavior of the filtered signal, it is known to implement adaptive filtering techniques, in which the transfer function of the filter is adapted as a function of local characteristics or amplitude parameters of the measured signals.

Known in particular is the Godbole et al. patent U.S. Pat. No. 8,508,330 which describes adaptive filtering techniques making it possible to improve the dynamic behavior of lighting command signals. However, the examples described essentially relate to low-pass type filters with a variable “strength” or cutoff frequency, which are not very well suited to the issue of detecting command objects with a touch-sensitive and contactless interface.

More generally, the issue of improving the dynamic behavior of the filtered signal in order to allow effective detections at large distances is shared by all capacitive detection systems. It is also found in anti-collision systems, as for example described in WO2004023067 by the applicant, which equip robots or mobile medical devices. In this case, the moving object (for example the robot) is equipped with a detection interface with capacitive electrodes that make it possible to detect the objects found nearby and avoid collisions.

The present invention aims to propose a method for filtering measurement signals from a capacitive detection system that allows strong noise rejection while minimizing disruptions on the dynamic behavior of the filtered signal.

The present invention also aims to propose a method for filtering measurement signals from a gestural and touch-sensitive interface that allows strong noise rejection while minimizing the disruptions on the dynamic behavior of the filtered signal.

The present invention also aims to propose a method for filtering measurement signals from a gestural and touch-sensitive interface that adapts the filtering relative to the actual signal-to-noise ratio of the measured signals.

The present invention also aims to propose a method for filtering measurement signals from a gestural and touch-sensitive interface that makes it possible to maximize the expanse of the detection zone for the control objects while minimizing the disruptions on the dynamic behavior of the measurement signals.

### DESCRIPTION OF THE INVENTION

This aim is achieved with a method for filtering a measurement signal Mi resulting from a capacitive coupling between a measurement electrode and at least one object of interest, characterized in that it comprises the following steps:
generating a filtered signal Mo from the measurement signal Mi, with the application of the first adaptive filtering function implementing a strength parameter Af depending on an electrical noise and the measurement signal Mi,
generating a derivative signal Der representative of variations of the filtered signal Mo or the measurement signal Mi,
generating a compensated signal Moc, by making a combination of the filtered signal Mo and said derivative signal Der.

According to the embodiments, the steps for generating signals described in the present document may comprise computing operations, in particular in the case of a digital implementation or computer or microcontroller implementation of the method according to the invention. This generation may also be done by other means, such as analog electronic means.

According to embodiments, the strength parameter Af may depend directly or by means of transformation on the measurement signal Mi at the current moment or at an earlier moment.

According to embodiments, the strength parameter Af may depend on the filtered signal Mo at a preceding moment, in which case it depends by means of transformations on the measurement signal Mi.

According to embodiments, the derivative signal Der may be generated so as to be representative, directly or indirectly (by means of a transformation), on variations of the filtered signal Mo or the measurement signal Mi. This derivative signal Der may in particular be generated:
from the measurement signal Mi filtered by a filter different from that applied to generate the filtered signal Mo;
from the measurement signal Mi to which a nonlinear saturation transformation is for example applied.

According to embodiments, the generation of the compensated signal Moc may be done:
with a linear combination of the filtered signal Mo and the derivative signal Der;
with a nonlinear combination of the filtered signal Mo and the derivative signal Der, for example to avoid saturations or minimum or maximum amplitude overruns of the compensated signal Moc if the compensation intended to accentuate the dynamics is too great.

According to embodiments, the method according to the invention may further comprise a step for generating the measurement signal Mi, with a determination of the inverse of a combination of:
a coupling capacitance Ci measured between the measurement electrode and at least one object of interest, and
an offset capacitance Coffset corresponding to a coupling capacitance for an object of interest situated at a predetermined limit distance from said measurement electrode.

The generation of the measurement signal Mi may in particular comprise:
a sum of the coupling capacitance Ci and the offset capacitance Coffset;
a linear combination or a nonlinear combination of the coupling capacitance Ci and the offset capacitance Coffset.

According to other embodiments, the method according to the invention may further comprise a step for generating the measurement signal Mi, with a determination of a ratio between an infinite capacitance Cinf corresponding to a capacitance as measured on the measurement electrode in the absence of an object of interest and a coupling capacitance Ci measured between said measurement electrode and at least one object of interest.

The generation of the compensated signal Moc may comprise a weighting of the derivative signal Der with an anticipation perimeter Da depending on the strength parameter Af.

The adaptive filtering function may comprise a low-pass type function.

The adaptive filtering function may comprise a recursive function with, at a moment k, a linear combination of:
a filtered signal Mo(k−p) from a preceding iteration at the moment k−p, weighted by the strength parameter at the moment k, Af(k), normalized to one,
the measurement signal at the moment k, Mi(k), weighted by the one's complement value of the strength parameter: 1−Af(k).

The adaptive filtering function may comprise a plurality of cascading recursive functions.

The index p may for example assume the value 1 to designate the immediately preceding iteration or a value greater than one to designate an older preceding iteration.

The determination of the strength parameter Af may comprise a determination of a maximum value between a noise strength parameter Afem depending on electrical noise, and a distance strength parameter Afz depending on one of the following signals: the measurement signal Mi, the filtered signal Mo(k−p) resulting from a preceding iteration at the moment k−p, the compensated signal Moc(k−p) from a preceding iteration at the moment k−p.

Preferably, the determination of the strength parameter Af is done by taking p=1, i.e., the iteration at the preceding moment.

Thus, according to embodiments, the distance strength parameter Afz may depend:
directly on the current measurement signal Mi(k) (or the measurement signal Mi(k−p) from a preceding iteration at the moment k−p for cases where the noise to be filtered is low); or
a transformation of the measurement signal Mi such that the filtered signal Mo(k−p) or the compensated signal Moc(k−p), obtained later in the processing chain of the signals; or
the measurement signal Mi(k) filtered by another filter and/or to which a nonlinear transform has been applied.

The distance strength parameter Afz therefore thus depends more or less directly on the measurement signal Mi(k) entering the filter.

The generation of the noise strength parameter Afem may comprise a calculation of a ratio between a predetermined reduced objective noise value Ob and a function of a measurement of the electrical noise Br(k).

The generation of the distance strength parameter Afz may comprise a calculation of the ratio between a predetermined filtered signal value in the absence of an object of interest Moz and the filtered signal Mo(k−p) resulting from a preceding iteration at the moment k−p.

The method according to the invention may further comprise steps of:
obtaining a plurality of measurement signals Mi for a plurality of electrodes;
if the time variation of a measurement signal Mi exceeds a predetermined threshold value for at least one electrode, using the smallest distance strength parameter Afz among the distance strength parameters Afz calculated for said plurality of electrodes, to generate the strength parameter Af of all of the electrodes from said plurality of electrodes.

The generation of the derivative signal Der may comprise an application of an adaptive derivative filtering function.

The adaptive derivative filtering function may comprise a recursive function.

The adaptive derivative filtering function may implement the strength parameter Af.

According to another aspect, an interface mechanism is proposed comprising:
a measurement interface provided with a plurality of measurement electrodes,
electronic means suited to produce capacitive coupling measurements between said measurement electrodes and at least one object of interest, and
calculation means arranged to implement the filtering method according to the invention.

According to embodiments, the interface mechanism according to the invention may comprise:
measurement electrodes distributed in a matrix arrangement on the measurement interface;
measurement electrodes and a measurement interface that are substantially transparent.

According to still another aspect, an apparatus of one of the following types is proposed: computer, telephone, smartphone, tablet, display screen, terminal, comprising an interface mechanism according to the invention.

According to another aspect, an interface mechanism is proposed comprising:
a measurement interface provided with a plurality of measurement electrodes,
electronic means suited to produce capacitive coupling measurements between said measurement electrodes and at least one object of interest, and
calculation means arranged to implement the filtering method according to the invention.

This interface mechanism may further be intended to equip a moving apparatus, for example of the robot or medical device type, so as to detect objects of interest or any type of object in the vicinity of the apparatus and avoid collisions.

According to still another aspect, an apparatus (for example of the robot, medical device or medical imaging device type) is proposed, that comprises an interface mechanism according to the invention arranged so as to be able to detect objects in the vicinity of the apparatus, and control means for avoiding collisions by using the information from the interface mechanism.

### DESCRIPTION OF THE FIGURES AND EMBODIMENTS

Other advantages and specificities of the invention will appear upon reading the detailed description of non-limiting implementations and embodiments, and from the following attached drawings:

FIG. 1 illustrates one embodiment of a control interface mechanism according to the invention, in sectional view,

FIG. 2 illustrates the trailing effect that appears during a quick movement of the control object above the control interface with linear low-pass filtering of the prior art,

FIGS. 3(a) and 3(b) illustrate the remnant effect that appears during a quick movement of the control object above the control interface with a linear low-pass filtering of the prior art,

FIG. 4 shows a flowchart of the filtering method according to the invention,

FIG. 5 shows examples of filter frequency transfer functions according to the invention, for cases where there is no electromagnetic disruption,

FIG. 6 shows examples of filter frequency transfer functions according to the invention, for cases with an object near the control interface.

It is well understood that the embodiments which will be described in the following are in no way limiting. One could in particular imagine variants of the invention only comprising a selection of features subsequently described isolated from other features described, if this selection of features is sufficient to confer a technical advantage or for distinguishing the invention from the state of the prior art. This selection includes at least one preferably functional feature without structural details, or with only a portion of the structural details, if this part alone is sufficient to give a technical advantage or to distinguish the invention compared to the state of the prior art.

In particular, all the variants and all the embodiments described can be combined with each other if at the technical level nothing prevents it.

In the figures, the elements common to several figures retain the same reference.

As previously explained, the purpose of the invention is to propose a method for processing measurement signals from a touch-sensitive and gestural control interface making it possible to optimize the noise rejection while limiting the dynamic disruptions of the measurement signal.

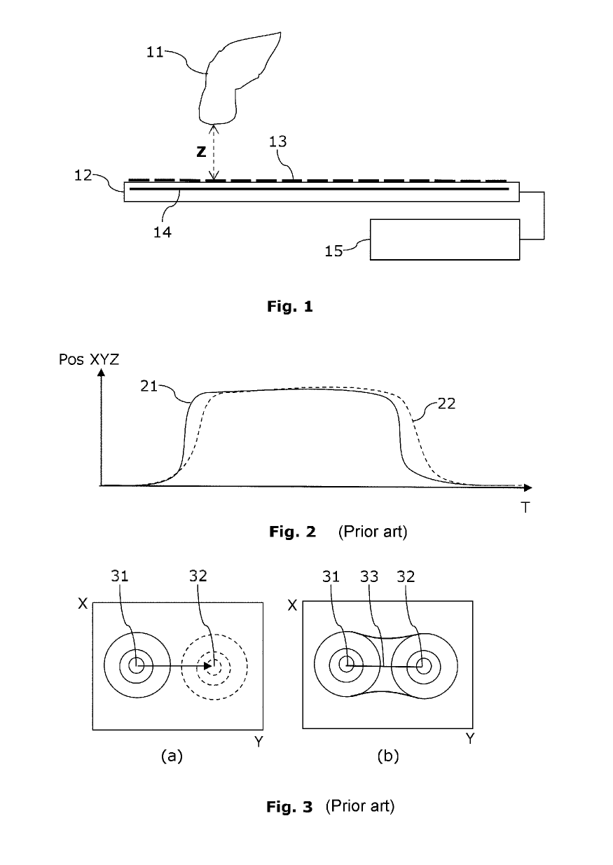

FIG. 1 shows one embodiment of a touch-and gestural control interface according to the invention integrated into a computer, tablet or telephone (smartphone) touchscreen.

The interface mechanism 12 comprises a plurality of capacitance measurement electrodes 13 distributed on a measurement surface, for example in a matrix arrangement.

In the case where the interface mechanism is superimposed on a display screen, the measurement electrodes 13 are made with one or more layers of transparent and electrically conducting material such as ITO (indium tin oxide).

The measurement electrodes 13 are connected to control electronics 15.

When a command object 11 such as a finger is near or in contact with the surface of the measurement electrodes 13, capacitive coupling is established between the command object 11 and the measurement electrodes 13. This capacitive coupling is measured by the control electronics 15.

According to one preferred embodiment, the measurement electrodes 13 and the control electronics 15 are made according to an embodiment described in document FR 2,949,007.

The control electronics 15 comprise means for exciting the measurement electrodes 13 at an alternating so-called “guard” electric potential.

It also comprises means for measuring the capacitance between measurement electrodes 13 and their environment or command objects 11 with a very high sensitivity. These capacitance measurement means are based on electronics partially referenced to the guard alternating voltage, at least in part with a charge amplifier.

The electrodes 13 are queried sequentially via a polling means. They are connected either to the electronics 15 or to the electric guard potential.

The command interface 12 also comprises a guard plane 14 or guard electrodes 14 arranged along the surface of the measurement electrodes 13 opposite the measurement zone, and subject to the alternating guard potential. This guard plane 14 makes it possible to avoid capacitive couplings between the measurement electrodes 13 and the parts of the electronics or the display screen at another electric potential (ground, for example).

The electronics are thus designed so as to nearly perfectly eliminate the capacitive couplings between the electrodes 13, or between electrodes 13 and the parts of the interface mechanism 12 subject to another electric potential.

When an object of interest, such as a finger 11, subject to an electric potential different from the guard potential approaches a measurement electrode 13, a capacitive coupling is established between them. The corresponding capacitance C is measured by the control electronics 15. Knowing the surface of the measurement electrode 13, the measurement of this capacitance C makes it possible to obtain a distance Z between the measurement electrode 13 and the object 11.

According to other embodiments, the measurement electrodes 13 and control electronics 15 can implement so-called “active guard” capacitance measurement techniques in which the detection electronics 15 are fully referenced to a ground potential. In these techniques, the measurement electrodes 13 and the guard elements 14 are also excited to an alternating guard potential on the one hand to allow a measurement of the coupling capacitances C between the electrodes 13 and command objects 11, and on the other hand to allow a rejection of the parasitic coupling capacitances between the electrodes 13 and their environment. However, the rejection of the parasitic coupling capacitances is not as good as in the preferred embodiment.

As previously explained, the detection of command objects 11 requires the measurement of the capacitive coupling C between this or these command object(s) 11 and the measurement electrodes 13. This capacitive coupling C changes as the inverse of the distance Z between the command object 11 and the considered electrode 13.

For large distances Z, the capacitances C to be measured therefore become very weak.

Yet, the measurement of the capacitance C is disrupted by many noise sources that are largely independent of the measurement, including:
the thermal noise intrinsic to the measurement electronics;
the noise caused by voltage sources outside the mechanism that interfere with the measurement signal. This noise may for example be generated upon connecting a charger to a battery-powered portable device.

It follows that the signal-to-noise ratio on the measurement of the capacitance C due to thermal or external noise changes with the distance Z like 1/Z².

It is therefore necessary to significantly filter the measurements to make the signal usable at large distances.

With reference to FIGS. 2 and 3, under these conditions, the use of conventional linear filters causes significant disruptions of the dynamic characteristics of the signal.

FIG. 2 illustrates the trailing effect generated by a linear low-pass filter during the rapid movement of a command object 11 above the command interface. The curve 21 shows a real movement of the object 11 in the volume (X, Y, Z) over time, and the curve 22 shows the trajectory as it is measured after filtering. A temporal and spatial offset of the measured position is observed that may be bothersome during the performance of quick movements.

FIGS. 3(a) and 3(b) illustrate the remnant effect generated by a linear low-pass filter during the rapid movement of a command object 11 above the command interface. FIG. 3(a) shows the isocapacitance curves of the capacitive coupling C, in the X-Y plane of the electrodes 13, when a command object 11 is respectively in a first position 31 and a second position 32.

In the absence of filtering, when a command object 11 is quickly moved from the first position 31 to the second position 32, the “images” illustrated by the isocapacitance curves centered on the first position 31, then on the second position 32 result successively, as illustrated in FIG. 3(a).

When a conventional linear filtering is applied, there is a risk of obtaining a remnant effect as illustrated in FIG. 3(b). One sees the image corresponding to the old position 31 not yet completely erased by the remnant due to the filtering, as well as a peak line 33 between the old image and the new image 32 showing local maximums both in the location of the old image 31 and between the old and new images 32. The result as it risks being interpreted by the system is the transient appearance of several objects 11 in positions 31, 32, 33, whereas there is only one that moves and that should have been detected only in the position 32. These multiple objects may wrongly trigger functions related to the presence of several objects (for example, pinching with 2 fingers).

In other words, to improve the measurement reach of the command interface and/or to improve its immunity to outside noise, it is necessary to apply effective filtering to the measurement signal. However, although this filtering is done with linear methods from the prior art, it may cause unacceptable deteriorations of the dynamic characteristics of the measurement signal.

The objective of the filtering method from the invention precisely is to produce filtering adapted to this application, in which:
the transfer function allows minimization of the lateness or delays, and
the filtering “strength” adapts to the actual signal-to-noise ratio characteristics of the measured signal, so as to minimize the impact of the filtering on the measurement signal.

Thus, the invention makes it possible to:
improve the signal-to-noise ratio nonlinearly, to avoid the deterioration of the signal-to-noise ratio at large distances Z, up to a limit of distinction of the shape of objects 11;
improve the signal-to-noise ratio in the presence of electromagnetic interference (EMI);
not degrade the dynamic response to retain a detection of quick movements, and not make phantom objects appear temporarily.

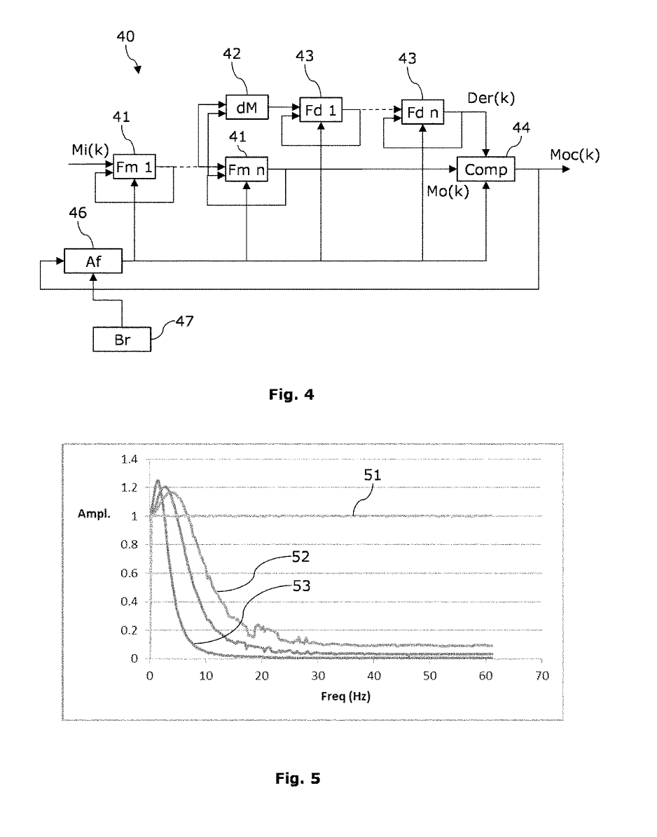

To that end, in reference to FIG. 4, the method according to the invention implements, for each “pixel” of a capacitive coupling image corresponding to a measurement electrode 13 of the command interface 12, a filtering of the measurement signal Mi from the electrode 13 in an adaptive filter 40, receiving, as a control of the strength of the filtering, the filtered signals Mo from the output of the filter and a detection signal for the electromagnetic and/or electrical noise in particular taking into account the electromagnetic disruptions and for example obtained by overall analysis of the fluctuations of the image. This filtering comprises the following steps:
for each pixel, application of one or preferably a cascade of recursive filters 41 to obtain a high-order filter (for example, order 3);
compensation 44 for the delay caused by the filter by adding a detection 42 of the variation or derivative of the signal, at the output of the cascade of filters 41;
filtering this derivative term 42 itself in a recursive derivative filter 43 of order 1 or more, receiving the same nonlinear filtering parameters as illustrated in FIG. 4, or parameters adapted as a function of the order of the filter or the desired dynamics;
upon each iteration, determining 46 the filtering parameter(s) Af as a function of the filtered signals Mo from the output of the filter and a detection signal of the electromagnetic or electrical noise.

We will now provide a detailed description of the steps of the method.

As previously explained, reference Mi(k) denotes the measurement signal measured at the iteration (or moment) k and brought to the input of the filter.

The measurement signal Mi(k) is a (position) signal representative of the distance Z between a measurement electrode 13 and one or more object(s) of interest 11. It is therefore calculated as a function of the inverse of the coupling capacitance C measured between this measurement electrode 13 and the object(s) of interest 11:

Mi(k)=1/(C(k)+Kc*Coffset). (Eq. 1)

The capacitance Coffset is defined from the capacitance that would be measured for a command object 11 situated at the furthest boundary of a predetermined detection zone. It is therefore a predefined value.

The coefficient Kc is chosen as a function of the desired behavior, preferably in the range [−0.5; −1]. For example:
with Kc=−1, the measurement signal Mi tends toward infinity when a command object 11 is at the boundary of the detection zone;
with Kc tending toward −0.5 for example, this behavior is avoided.

Alternatively, the measurement signal Mi(k) may be calculated as follows:

Mi(k)=Cinf/C(k). (Eq. 2).

The capacitance Cinf is the capacitance that would be measured on the electrode 13 in consideration in the absence of a command object. It is therefore also a predefined value. With this calculation mode, the measurement signal Mi(k) is a normalized signal, which is equal to 1.0 in the absence of an object 11 and which tends towards 0.0 if an object 11 is close to the electrode 13.

The method according to the invention comprises a step for calculating a filtered signal Mo(k).

To that end, a filter is applied made up of recursive cells 41 that perform an adaptive filtering function depending on a strength parameter Af(k). Preferably, several recursive cells 41 are implemented in cascade to produce a filter of an order greater than 1.

According to one preferred embodiment, three recursive cells 41 are implemented.

Each recursive cell with index c implements the following filtering function:

Mo(k, c)=(1−Af(k))*Mo(k, c−1)+Af(k)*Mo(k−1, c) (Eq. 3)

Mo(k, c−1) corresponds to the signal at the output of the preceding cascaded cell c−1. For the first cell, Mo(k, c−1)=Mo(k, 0)=Mi(k).

Mo(K−1, c) corresponds to the signal at the output of the cell c in the preceding iteration k−1, stored in memory.

The output signal of the last cell Mo(k, c) is the filtered signal Mo(k).

Af(k) is the parameter that governs the strength of the filter. This parameter, whose the calculation is outlined below, varies between the values zero and one. Value 0 corresponds to no filtering, and value 1 corresponds to a limit (not to be reached) for very high filtering.

For a filter made up of three recursive cells 41, the following adaptive filtering function is therefore implemented:

Mo(k, 1)=(1−Af(k))*Mi(k)+Af(k)*Mo(k−1, 1);

Mo(k, 2)=(1−Af(k))*Mo(k, 1)+Af(k)*Mo(k−1, 2);

Mo(k)=(1−Af(k))*Mo(k, 2)+Af(k)*Mo(k−1); (Eq. 4)

The method according to the invention next comprises a step of dynamic compensation for the delay introduced by the filter 41.

To that end, a time derivative 42 of the filtered signal Mo(k) is taken. The time variation is calculated:

dM(k)=Mo(k)−Mo(k−1) (Eq. 5)

Then the noise is filtered from the variation signal dM(k), to obtain the derivative signal Der(k).

To that end, a derivative filter is applied made up of recursive cells 43 that perform an adaptive derivative filtering function depending on a derivative strength parameter Af′(k). Several recursive derivative cells 43 are implemented in a cascade to make a filter of order greater than 1.

Thus, each recursive derivative cell with index c implements the following filtering function:

Der(k, c)=(1−Af′(k))*Der(k, c−1)+Af′(k)*Der(k−1, c) (Eq. 6)

Der(k, c−1i) corresponds to the derivative signal at the output of the preceding cascaded cell c−1i. For the first cell, Der(k, c−1i)=dM(k).

Der(k−1, c) corresponds to the derivative signal at the output of the cell c in the preceding iteration k−1, stored in memory.

The output signal of the last cell Der(k, c) is the derivative signal Der(k).

Af′(k) is the parameter that governs the strength of the filter. This parameter varies between the values of zero and one. Value 0 corresponds to no filtering, and value 1 corresponds to a limit (not to be reached) for very significant filtering.

According to one preferred embodiment:
the recursive derivative cells 43 are identical to the recursive cells 41 of the filter applied to the measurement signal;
the same strength parameter Af′(k)=Af(k) is applied;
three recursive derivative cells 43 are implemented.

Under these conditions, the following adaptive derivative filtering function is therefore implemented:

Der(k, 1)=(1−Af′(k))*dM(k)+Af′(k)*Der(k−1, 1);

Der(k, 2)=(1−Af′(k))*Der(k, 1)+Af′(k)*Der(k−1, 2);

Der(k)=(1−Af′(k))*Der(k, 2)+Af′(k)*Der(k−I); (Eq. 7)

with Af′(k)=Af(k).

The drift signal Der(k) is used to compensate the delay introduced by the filter applied to the measurement signal.

To that end, the derivative signal Der(k) is combined with the filtered signal Mo(k) to produce a compensated signal Moc(k) as follows:

Moc(k)=Mo(k)+Der(k)*Da(k) (Eq. 8)

The second filtered signal Moc(k) corresponds to the output signal of the filter.

The anticipation parameter Da(k) is calculated as a function of the strength parameter Af(k) as follows:

Da(k)=Sm*OF*(1/(1−Af(k))−1). (Eq. 9)

The constant OF is representative of the order of the filter. In the described embodiment, OF=3 is used.

The constant Sm makes it possible to adjust the dynamic compensation of the filter. An increase of Sm over-accentuates the transient response. In the described embodiment, Sm=0.7 is used.

The strength parameter Af(k) at the moment k is determined taking into account the filtered signal Mo(k−1) at the preceding moment k−1 (or the measurement signal Mi or the compensated signal Moc) and a measured noise level. It thus makes it possible to adapt the filtering to the noise level or the signal-to-noise ratio at the considered moment k.

More specifically, this strength parameter Af(k) is chosen as being the maximum value between a distance strength parameter Az(k) depending on the filtered signal Mo(k−1) from the preceding iteration at the moment k−1 and a noise strength parameter Afem(k) depending on a noise measurement:

Af(k)=Max{Afz(k); Afem(k)}, (Eq. 10)

or, according to an equivalent formulation,

Af(k)=1−Min{(1−Afz(k)); (1−Afem(k))}. (Eq. 11)

The functions Max{} and Min{} respectively produce the maximum and minimum values.

The noise strength parameter Afem(k) depending on a noise measurement is calculated from noise measurements Br(k) and an objective reduced noise parameter Ob:

Afem(k)=Max{1−Rt_i(Ob/P(Br(k))); 0}. (Eq. 12)

The parameter Ob is a constant objective value, to be achieved after filtering. The noise measurement Br(k) is below the level or amplitude of the noise, for example a beating noise due to electromagnetic disruptions, detected at the moment k. The function P( ) is a polynomial (for example of order 3), with saturation. Rt_i( ) is the root function of order i, or the cubic root in the described embodiment.

Since the noise measurement Br is generally done over the entire command interface, the noise strength parameter Afem is identical for the filtering of all of the measurement signals Mi.

The distance strength parameter Afz(k) is calculated using the following relationship:

Afz(k)=Max{1−Rt_i(Ft*Moẑ2/Mo(k)̂2); 0}. (Eq. 13)

Moz is the value of the variable measured at the input with no object 11. It is a predetermined value.

Ft is the desired filtering level for an object of interest 11 far from the sensors 13, but at a distance where it is still detectable. For example, a value Ft=0.01 makes it possible to provide an improvement of 40 dB on rapid noises for the maximum desired distance Z, which causes a similar improvement on a beating noise EMI (with narrow band), or of 10.5 dB on a white-noise spectrum, in the case of an order 3 filter with the stated values.

In the embodiment described thus far, the filtering calculations are done independently for the measurements from distinct electrodes 13.

According to one alternative embodiment, to avoid distortions in the presence of rapid movements of command objects 11 above the interface, the same first strength parameter Afz(k) is used for filtering of the measurement signals Mi from a set of electrodes 13 corresponding to part or all of the command interface 12.

In this embodiment, when the time variation (for example given by the amplitude of the variation signal dM or the derivative signal Der) of at least one measurement signal from the measurement electrode 13 under consideration is above a predetermined threshold (applied with a hysteresis):
The distance strength parameter Afz_m(k) that produces the lowest filtering strength, i.e., the one for which the term (1−Afz(k)) is the greatest is determined from among the distance strength parameters Afz(k) calculated for the measurement electrodes 13 under consideration;
This distance strength parameter Afz_m(k) is applied for the filtering of the measurement signals Mi from the set of measurement electrodes 13 under consideration.

In this case, and when the noise strength parameter Afem is shared by all of the measurement signals, the strength parameter used for filtering of all of the measurement signals for the considered set is identical and corresponds to:

Af(k)=1−Min{(1−Afz_m(k)); (1−Afem(k))}. (Eq. 14)

According to another alternative embodiment, for the filtering of the measurement signals Mi from a set of electrodes 13 corresponding to part or all of the command interface 12, the same strength parameter Af(k) is used as calculated by Eq. 14, using the strength parameter Afz_m(k) that produces the lowest filtering strength among the considered measurement signals, in all cases.

According to alternative embodiments, it is possible to implement different strength parameters Af for the recursive filtering cells 41 and the recursive derivative filtering cells 43. For example:
it is possible to implement a first strength parameter Af for the recursive filtering cells 41 and a second strength parameter Af for the recursive derivative cells 43;
it is possible to implement a different strength parameter Af for at least part of the recursive filtering cells 41 and/or at least part of the recursive derivative cells 43.

These different strength parameters Af can for example be calculated by applying different predetermined coefficients or parameters. It is thus for example possible to modulate the transfer function of the filter implemented to obtain a particular shape.

FIG. 5 shows examples of low-pass filter frequency transfer functions according to the invention, for cases with no electromagnetic interference, or at least when the noise strength parameter Afem is not dominant in the calculation of the strength parameter Af. The curve 53 shows the case of a measurement electrode 13 detecting an object 11 that is remote or missing, for which the measurement signal Mi is maximal (Mi=1). In this case, the filtering is maximal. The curve 51 shows the case of a measurement electrode 13 detecting an object 11 close to the surface of the interface 12, which corresponds, in the described embodiment, to Mi<33. In this case, there is no longer any filtering applied, which corresponds to a filtering transfer function equal to 1 for all frequencies. For the intermediate positions (curve 52), the filtering transfer functions have cutoff frequencies that get higher as the detected object 11 comes closer to the surface of the command interface 12.

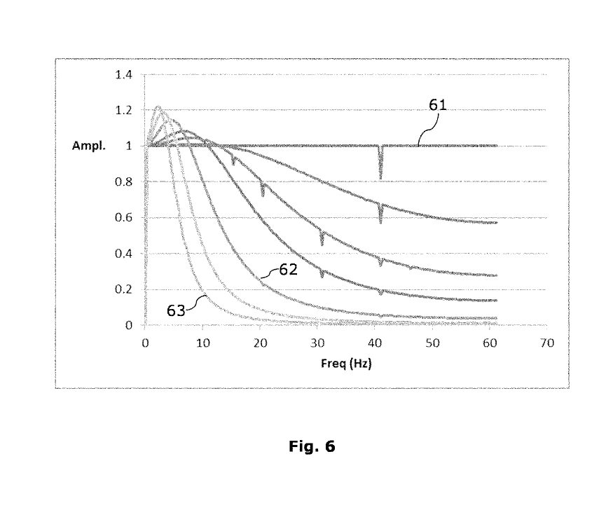

FIG. 6 shows examples of low-pass filter frequency transfer functions according to the invention, for cases with an object 11 close to the command interface 12. These curves correspond to Mi<0.33 in the described embodiment. The transfer functions are shown for different levels of electromagnetic interference. For low interference levels (curve 61), there is no longer any filtering applied, which corresponds to a filtering transfer function equal to 1 for all frequencies. When the detected electromagnetic interference level increases (curves 62, then curve 63), the filtering transfer functions have increasingly low cutoff frequencies, so as to increase the effectiveness of the filtering. The curve 63 corresponds to a reduction in electromechanical noise by 50 when it is situated at the highest detected frequencies.

Of course, the invention is not limited to the examples which were just described and many improvements could be made to these examples without leaving the scope of the invention.

1. A method for filtering a measurement signal Mi resulting from a capacitive coupling between a measurement electrode and at least one object of interest, comprising:
generating a filtered signal Mo from the measurement signal Mi, with an application of an adaptive filtering function implementing a strength parameter Af depending on an electrical noise and the measurement signal Mi;
generating a derivative signal Der representative of variations of the filtered signal Mo or the measurement signal Mi; and
generating a compensated signal Moc, by making a combination of the filtered signal Mo and said derivative signal Der.

2. The method according to claim 1, further comprising generating the measurement signal Mi, with a determination of an inverse of a combination of:
a coupling capacitance Ci measured between the measurement electrode and the at least one object of interest, and
an offset capacitance Coffset corresponding to a coupling capacitance for an object of interest situated at a predetermined limit distance from said measurement electrode.

3. The method according to claim 1, further comprising generating the measurement signal Mi, with a determination of a ratio between an infinite capacitance Cinf corresponding to a capacitance as measured on the measurement electrode in an absence of an object of interest and a coupling capacitance Ci measured between said measurement electrode and at least one object of interest.

4. The method according to claim 1, wherein the generation of the compensated signal Moc comprises a weighting of the derivative signal Der with an anticipation perimeter Da depending on the strength parameter Af.

5. The method according to claim 1, wherein the adaptive filtering function comprises a low-pass type function.

6. The method according to claim 1, wherein the adaptive filtering function comprises a recursive function with, at the moment k, a linear combination of:
a filtered signal Mo(k−p) from a preceding iteration at the moment k−p, weighted by the strength parameter at the moment k, Af(k), normalized to one; and
the measurement signal at the moment k, Mi(k), weighted by a one's complement value of the strength parameter: 1−Af(k).

7. The method according to claim 6, wherein the adaptive filtering function comprises a plurality of cascading recursive functions.

8. The method according to claim 6, wherein a determination of the strength parameter Af comprises a determination of a maximum value between a noise strength parameter Afem depending on electrical noise, and a distance strength parameter Afz depending on one of the following signals: the measurement signal Mi, the filtered signal Mo(k−p) resulting from a preceding iteration at the moment k−p, the compensated signal Moc(k−p) from a preceding iteration at the moment k−p.

9. The method according to claim 8, wherein the generation of the noise strength parameter Afem comprises a calculation of a ratio between a predetermined reduced objective noise value Ob and a function of a measurement of the electrical noise Br(k).

10. The method according to claim 8, wherein the generation of the distance strength parameter Afz comprises a calculation of a ratio between a predetermined filtered signal value in an absence of an object of interest Moz and the filtered signal Mo(k−p) resulting from a preceding iteration at the moment k−p.

11. The method according to claim 10, further comprising:
obtaining a plurality of measurement signals Mi for a plurality of electrodes;
if a time variation of a measurement signal Mi exceeds a predetermined threshold value for at least one electrode, using the smallest distance strength parameter Afz among the distance strength parameters Afz calculated for said plurality of electrodes), to generate the strength parameter Af of all of the electrodes from said plurality of electrodes.

12. The method according to claim 1, wherein the generation of the derivative signal Der comprises an application of an adaptive derivative filtering function.

13. The method according to claim 12, wherein the adaptive derivative filtering function comprises a recursive function.

14. The method according to claim 12, wherein the adaptive derivative filtering function implements the strength parameter Af.

15. An interface mechanism, comprising:
a measurement interface provided with a plurality of measurement electrodes;
electronic means suited to produce capacitive coupling measurements between said measurement electrodes and at least one object of interest; and
calculating means arranged to implement the filtering of claim 1.

16. The interface mechanism according to claim 15, further comprising measurement electrodes distributed in a matrix arrangement on the measurement interface.

17. The interface mechanism according to claim 15, further comprising measurement electrodes and a measurement interface that are essentially transparent.

18. An apparatus of one of the following types: computer, telephone, smartphone, tablet, display screen, terminal, comprising an interface mechanism according to claim 1.
